(19) United States
(12) Patent Application Publication
(10) Pub. No.: US 2018/0132096 A1
(43) Pub. Date: May 10, 2018

(54) DIFFERENTIAL TRACKING AND MOBILITY MANAGEMENT IN COMMUNICATION NETWORKS

(71) Applicant: ZTE Corporation, Shenzhen (CN)

(72) Inventor: David Huo, Newton, NJ (US)

(21) Appl. No.: 15/807,547

(22) Filed: Nov. 8, 2017

Related U.S. Application Data
(60) Provisional application No. 62/419,358, filed on Nov. 8, 2016.

(51) Int. Cl. H04W 8/08; H04W 60/04; H04W 28/16

(52) U.S. Cl. CPC H04W 8/08; H04W 28/16; H04W 60/04

(57) ABSTRACT

In a next generation wireless network, user devices with different capabilities and demands on network services may be mobile within the coverage area of a wireless communication network with different speeds and patterns. A network-side server may associate network slices with different user device capabilities and/or different user device capabilities such that signaling and book-keeping overhead to provide network services to such disparate user devices is minimized, commensurate with mobility and capability characteristics of user devices.

### CROSS-REFERENCE TO RELATED APPLICATIONS

This patent document claims the benefit of priority of U.S. Provisional Patent Application No. 62/419,358, filed on Nov. 8, 2016. The entire content of the before-mentioned patent application is incorporated by reference as part of the disclosure of this application.

### TECHNICAL FIELD

This document relates to systems, devices and techniques for wireless communications, including next generation network architecture.

### BACKGROUND

Efforts are currently underway to define next generation communication networks that provide greater deployment flexibility, support for a multitude of devices and services and different technologies for efficient bandwidth utilization.

### SUMMARY

This document describes technologies, among other things, for allocating network slice resources to mobile devices.

In one example aspect, a method of wireless communication for updating tracking areas associated with one or more user equipment of a wireless communication network is disclosed. The method includes generating, by a network-server, a tracking area list comprising multiple entries, wherein each entry of the tracking area list comprises one or more tracking areas and at least some entries differ from each other based on their geographic coverage, associating each of the one or more user equipment with at least one entry from the tracking area list, monitoring movement of a given user equipment, updating, based on the movement, association of the given user equipment to a different entry from the tracking area list, and communicating, in an association update message, the updating using a single bit indicative of the updating.

In another aspect an apparatus for updating tracking areas associated with one or more user equipment of a wireless communication network is disclosed. The apparatus may include a network-server including a processor configured to at least generate a tracking area list comprising multiple entries, wherein each entry of the tracking area list comprises one or more tracking areas and at least some entries differ from each other based on their geographic coverage. The processor may be further configured to associate each of the one or more user equipment with at least one entry from the tracking area list. The processor may further be configured to monitor movement of a first user equipment. The processor may further be configured to update, based on the movement, association of the given user equipment to a different entry from the tracking area list. The apparatus may further include a transmitter to transmit, to the first user equipment in an association update message, a single bit indicative of the updating.

In another example aspect, a method, implemented in a user device, is disclosed. The method includes storing, in the local memory, a tracking area list comprising multiple entries, wherein each entry of the tracking area list comprises one or more tracking areas and at least some entries differ from each other based on their geographic coverage, storing a tracking area identifier in a local memory at the user device, wherein the tracking area identifier a first entry in the tracking area list, receiving a tracking area change message comprising exactly one bit, and updating, based on the tracking areas change message, the tracking area identifier to a different value indicative of a second entry in the tracking area list.

In yet another aspect, a wireless communication apparatus implemented at a user device is disclosed. The apparatus may include a processor configured to at least store, in a local memory, a tracking area list comprising multiple entries, wherein each entry of the tracking area list comprises one or more tracking areas and at least some entries differ from each other based on their geographic coverage. The processor may be further configured to store a tracking area identifier in the local memory at the user device, wherein the tracking area identifier includes a first entry in the tracking area list. The apparatus may further include a receiver configured to receive a tracking area change message comprising exactly one bit. The processor may be further configured to update, based on the tracking area change message, the tracking area identifier to a different value indicative of a second entry in the tracking area list.

The following features may be included in any combination. The single bit indicating of the updating may include signaling one of increasing geographic reach of the tracking area associated with the given user equipment or reducing geographic reach of the tracking area associated with the given user equipment. At least some entries in the tracking area list may include tracking areas that at least partially geographically overlap. The multiple entries of the tracking area list may have an associated granularity indicative of geographic coverage. A default network slice may be associated for each of the one or more user equipment such that each user equipment or device is permitted to initially access network services through a corresponding default network slice. The default network slice may control the distribution of network functions among other slices in the wireless communication network.

The details of one or more implementations are set forth in the accompanying attachments, the drawings, and the description below. Other features will be apparent from the description and drawings, and from the claims.

### BRIEF DESCRIPTION OF THE DRAWINGS

FIG. 1 shows an example of state transitions to manage network slice resources in a network supporting device mobility, in accordance with some example embodiments.

FIG. 2A shows an example of network function sharing among network slices, in accordance with some example embodiments.

FIG. 2B shows an example of a mapping between network slices and tracking areas of a mobility management embodiment, in accordance with some example embodiments.

FIG. 3 shows an example of transitions among TAs, based on a single bit change indication.

FIG. 4 is a block diagram illustration of a communications apparatus, in accordance with some example embodiments.

FIG. 5 shows a flowchart of an example method of wireless communication, in accordance with some example embodiments.

FIG. 6 shows a flowchart of an example method of wireless communication.

FIG. 7 depicts three slices, in accordance with some example embodiments.

FIG. 8 depicts examples of security functions in a sliced network, in accordance with some example embodiments.

FIG. 9 depicts a non-roaming NextGen architecture, in accordance with some example embodiments.

Like reference symbols in the various drawings indicate like elements.

### DETAILED DESCRIPTION

The last few years has seen an explosive growth in wireless communication devices. In the next few years, this growth is expected to continue, with more and more devices being able to wirelessly communicate. Research and development work is currently underway to design the architecture of next generation communication networks (NextGen) that will support the deployment and operation of such new devices.

NextGen networks are expected to support devices which may have significantly different characteristics from each other. The NextGen devices may range from very low complexity devices to extremely complex devices. For example, some devices may be at sub-dollar price points and may include minimal processing power, while other devices may cost hundreds of dollars and may include sophisticated graphics and processing capabilities. Similarly, some devices may be designed to operate without mobility, while some other devices may operate with high mobility.

Providing next generation services to devices with such disparate capabilities and use cases would benefit from the flexible schemes described in this patent document. Existing network resource allocations tend to be inefficient because they fail to take into account differing device capabilities. As further described in the present document, networks that provide resources commensurate with device capabilities such as device mobility and/or diversity of network slices, provide a flexible and efficient architecture for resource utilization in the NextGen architecture.

Some embodiments of the disclosed technology are described by using the example of the 5G network architecture that uses network slices to provide services to user devices, also called user equipment (UE). Furthermore, the disclosed techniques have been described using state diagrams. However, actual implementations may use state-based logic or other ways, e.g., stateless logic such as analog computing, of implementing the disclosed techniques. However, the disclosed technology is equally applicable to other networks.

Examples of State Transition of the UE-NS Relation (User Equipment-Network Slice)

A network slice is fully functional network capability providing end-to-end services. It consists of network functions (physical or virtualized) and is implemented on a software/hardware infrastructure that is either operated or rented by the operator. In this infrastructure, a UE accesses a service through a network slice. In a NextGen network, there are different types of slices (for different E2E services) and different types of UEs (for different purposes). It is necessary to have a clear view on the possible logical relations between UEs and NSs (network slice), so that an apt scalable architecture can be developed. The event that an UE is present in a specific NS is triggered by an action, predefined by the operator based on subscription and initiated by the subscriber spontaneously based on service need.

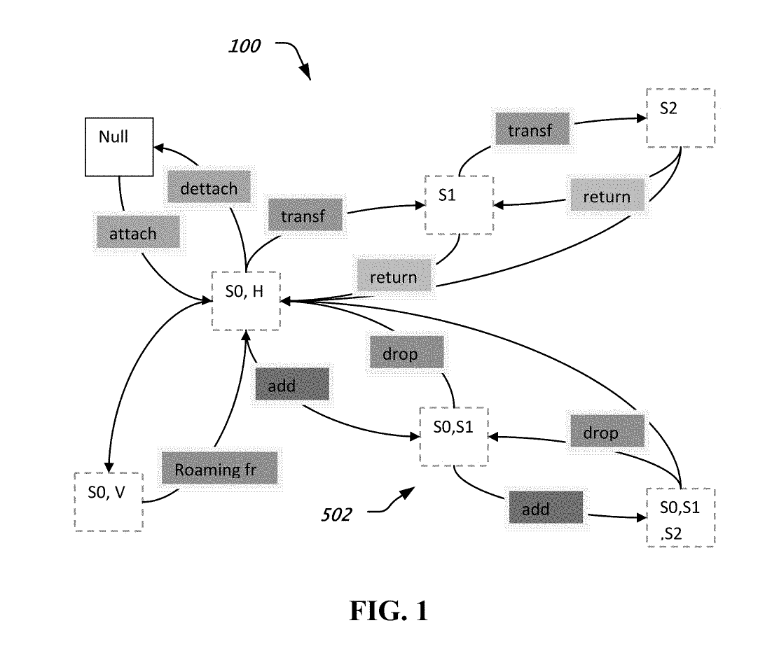

FIG. 1 is an example of a graph 100 that consists of component states and trigger events, where components: S0, S1, S2 and S3 refer to slice 0, slice 1, slice 2, and slice 3, respectively.

Trigger Events: A state transition is triggered by one of following events:
Attach, Detach
Transfer, Return
Add, Drop
Roaming (to, from)

In order for diverse services to be provided, adequate to the UE being used, the state machine of the architecture may likely have two types of topology: line and tree. The graph 100 shows these two topologies of state transition, where the tree is shown collapsed in a line for the sake of space saving (e.g., 502).

Network Functions and Fractions (Features)

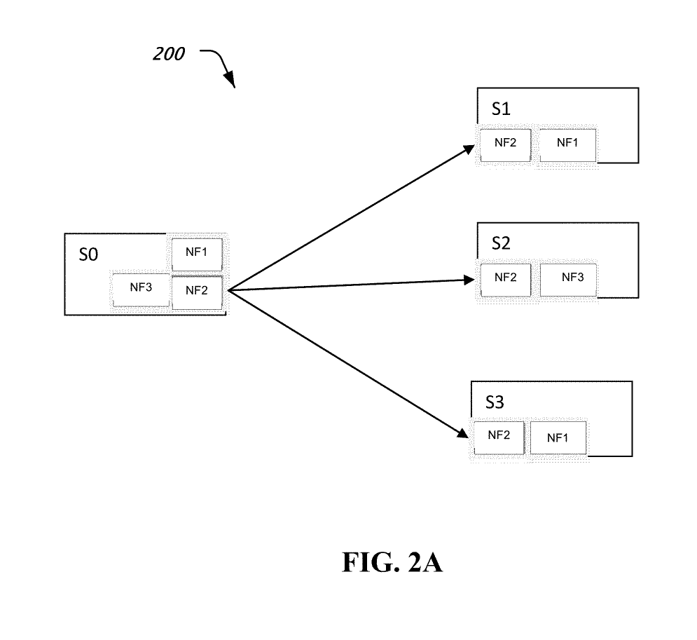

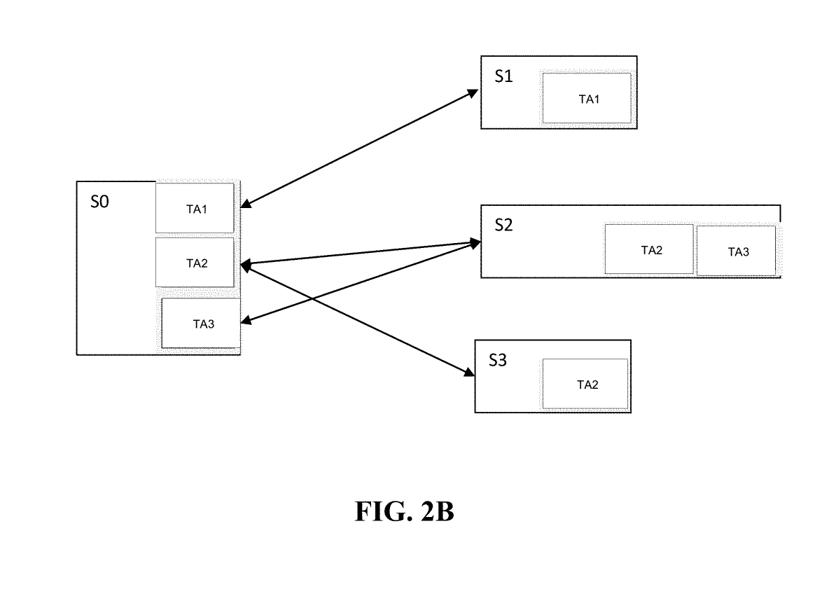

FIG. 2A shows an example of distribution among slices of network functions/features (NF) distribution. In FIG. 2A, S0 may be the default slice. Although FIG. 2A shows that the S0 maintains all NFs (NF1, NF2, and NF3), implementation can also choose to assign the default slice the minimum set of NFs. The decisions depend on the operator and vendor. Distribution of network functions among slices is, however, controlled/initiated by a default slice, for example S0.

Differentiated Mobility Management Function (MMF)

FIG. 2B shows an example of mobility management functions with differentiated tracking area (function features) in a sliced network. For example, in some embodiments, the default slice supports complete MMF, while other slices fractional MMF.

S0, S1, S2 and S3 refer to slice 0, slice 1, slice 2, and slice 3, respectively.

TA1, TA2 and TA3 indicate different sizes, or types, of tracking area (TA).

How the tracking area is defined and used by each slice is subject to individual deployments. However, the disclosed architecture allows for differentiated MMF, in particular allow multiple TAs to be defined and available for each slice to choose from. This is construed as an additional flexibility in NextGen, instead of a one-size-for-all solution, as is the case for present-day technology.

Network Assisted TAU

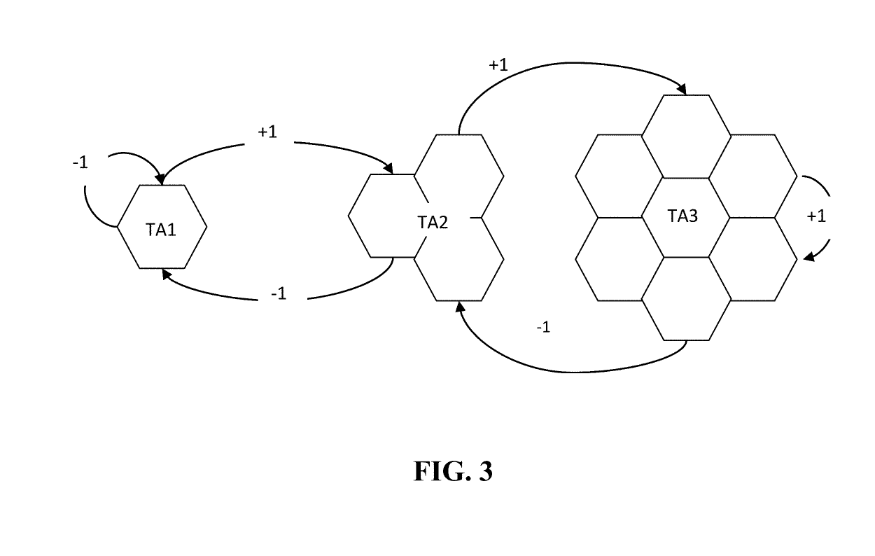

Based on the assumption that there are multiple types of TA defined over the same geographical area and a network slice implemented N, say N=3 in FIG. 3, different TAs to adapt to different mobility levels of the UE dwelling on this slice. The different types of TA are given in a list to be broadcast in the network and the list is ordered according to operator defined criteria.

Network assisted tracking area update (NATAU) allows network to send a (single bit) message to command the UE to change its stored TAI (TA identifier), so that UE can change from one TA to another TA, i.e., moving up or down on the TA list. FIG. 3 shows an example of transitions among TAs, based on a single bit change indication. This process converges as long as TAs defined are indeed different and UE's mobility is reasonably finite.

The trigger event for the change command is a decision logic based on the statistics collected by the network about the UE. This is based on proprietary algorithm of the operator; it may contain parameter such as observation window in time and switching threshold. A simple model underlying the statistics can be the frequency of TA-boundary crossing of the UE. When this frequency exceeds a threshold, the network may ask the UE to change to a rather larger TA, i.e., up on the TA list.

Alternatively, the statistics can also be collected by the UE and reported to the network, so that the network can make final decision based on global knowledge about all UEs, traffic situation and network resources.

Since different TAs have different sizes and other features, when they are adapted to different mobility levels, this mechanism allows for the network to minimize the unnecessary TAU initiated by the UE and the number of paging messages sent to the UE due to incoming traffic triggered session set-up.

The enabler for this feature requires introduction of the control bits on the interface between core network and the UE. FIG. 3 shows an example embodiment in which TA1 comprises one cell, TA2 includes three adjacent cells while TA3 includes 7 adjacent cells. Put differently, the relative size of the three tracking areas, in terms of the number of base stations serving them, are related by TA1<TA2<TA3. Accordingly, the transitions from the smaller tracking area to the larger area may be indicated by a “+1” bit and the transition to a smaller tracking area may be indicated by a “−1” bit. When the TA is smallest possible, a “−1” may transition to itself, e.g., no change in the tracking area level. Similarly, when TA corresponds to a largest TA, a “+1” transition bit may “loop back” to the same TA. In the embodiment depicted in FIG. 3, a direct transition from TA3 to TA1 is precluded because due to finite speed and/or processing power of mobile devices, it may take a certain amount of time for the mobile device to transition from between TA1 and TA3 (in either direction), thereby giving the network time to update the TA using a single bit transition.

The following section provides additional details for differential tracking area procedures which networks can update TAs for mobile devices using various probabilistic and/or statistical algorithms. For example, in some embodiments, a one-dimensional model may be used and may be dependent on the speed of travel of a mobile device. In some embodiments, a two-dimensional model may be used.

Differential Tracking Area Procedure

Network slicing is an important component in the architecture of the NextGen communication system, where each slice provides a complete end-to-end service, such as those provided by traditional telecommunications networks. Thus, when entertaining multiple slices, a NextGen may a flexible mechanism for appropriate mobility management that enhances the adaptive efficiency for the service provided on the one hand, and achieve power and cost saving on the other hand. An architecture for this purpose can be enabled by differentiated mobility management proposed here.

Network slices are introduced to enable differentiated end-to-end provisioning with flexible management. To accomplish this goal, the mobility management and cost efficient operation, just as the QoS and security, may be designed to adapt to the need of different types of slices. There are features of the mobility management that are common to slices, but there are also features that ought to be implemented for some slices but not other slices. Only in this way can the network achieve optimized resource utilization and reduced the overall operation cost, in terms of money and environment.

A cellular network may maintain user availability using tracking areas, where a tracking area is a group of contiguous cells. A call to a mobile user in a tracking area is initiated by a paging signal to cells within the tracking area, as the network cannot know exactly where the mobile user is at the time of incoming call. Having received the page, the mobile user responds to the network with a session set-up procedure initiated from the cell in which the user received the page. As the user can be moving out of the tracking area, the mobile equipment is required to initiate tracking area update (TAU) procedure whenever it finds itself in a new tracking area. How does it know when it has to do the TAU? There are two approaches:
The network include the tracking area information in its cell broadcast, which the mobile equipment is obliged to listen whenever it moves into a new cell. Thus, the mobile equipment is aware of the tracking area.
Alternatively, the mobile equipment activates TAU periodically based on a timer set by the network or the mobile equipment itself, so that the tracking area is transparent to the mobile equipment.

There are obvious pros and cons to both approaches. For 5G the selection has to consider the following factors:
Services to be supported by 5G may have dispersed mobility, ranging from static (Home IoT, Factory Automation) to high speed (train, vehicle).
Management of 5G is supposed to be flexible and efficient in order to support the diverse envisaged services, so that network slicing will be an important architecture component.
NextGen(5G) system is expected to be green, hence power and resource saving is to be taken into account consistently in the architecture design.

Based on these considerations, a network controlled TAU procedure has clear advantage.

Network controlled TAU procedure assumes:
Tracking area identifier (TAI) be broadcast by the access network.
Mobile equipment is required to perform TAU once it finds its stored TAI does not match that received from the cell broadcast.

Before moving on to details, a definition of mobility is due. Mobility is physically measurable and quantifiable, e.g., the distance a mobile equipment traveled in a given time period. Given that location is better intrinsically determined by cells through the cell identifier in a cellular network, it is convenient to define the frequency of TA boundary crossing of a mobile equipment as the measure for mobility. Thus, for a static user equipment the mobility is zero, while for a high speed user the mobility value depends on the cell geometry and magnitude.

Another challenge of an adequate TAU procedure is to accommodate the network slicing in NextGen(5G). The network slicing allows for multiple end-to-end services provisioning by independent enterprises using a common infrastructure. According to the concept, each slice is initiated to support a certain type of services. As each service may have an intrinsic mobility characteristic, e.g., smart metering has no mobility, factory automation has low mobility and incumbent subscriber service has a range of different mobility levels. As the mobility is one of the characteristic parameter of a network slice, the tracking area update procedure should support any kind of slices. In summary, a versatile mobility management procedure ought to support the following two scenarios simultaneously:
Homogeneous mobility: User equipment have roughly the same mobility in the network slice, be it low or high.
Heterogeneous mobility: User equipment in the network slice have diverse mobilities, both low and high.

Differential Tracking Area

Different granularities of tracking area (TA) are introduced, referred to as TA levels and measured by size of the covered area. For instance the TA levels can be defined by:
Level 1 TA consists of a single cell
Level 2 TA consists of three mutual contiguous cells
Level 3 TA consists of seven symmetrical contiguous cells
Level 4 TA consists of . . . etc

Different granularities apply to different mobilities. We will confine ourselves with only the first three granularities in the following discussion, because higher order granularities follow the same principle.

One of the working assumptions here is that each UE is associated with at least one network slices and it is always possible for the UE to identify a default slice, from which it attaches to the infrastructure via authentication. Then, we have the following scenarios:
The default slice supports homogeneous mobility only. Hence it broadcasts only one TA granularity tailored for the service specific to the slice.
The default slice supports heterogeneous mobility. Hence it broadcasts a multiple TA granularities, allowing for UE adaptation.

The first scenario does not require further elaboration, it is rather the second scenario that is worth more detailed investigation.

Mobility management in NG is designed for all network slices. It is expect to provide differentiated functions to different slices as appropriate to the services carried by the respective slice. Thus, the basic framework may include mobility features, so that each slice can select a subset. An UE obtains the mobility function designated to the slice when it join that slice. In case the UE accesses two slices simultaneously, negotiation occurs between the two concerned slices in this regard and the UE is notified the designated mobility functions, pertinent to one or the other slice. Given the mobility features offered by the slice is optimized after adaptation to the service, it is reasonable to assume the union of the two mobility functions is appropriate for the UE, so that no services is impaired, i.e., the UE takes a tracking area of

max{TA1,TA2} (1)

where TA1 and TA2 are the tracking areas of slice 1 and slice 2, respectively.

Adaptation Procedure

Since CN (core network) and RN (radio access network) are separate entities in the NextGen architecture, there is a communication between CN (or slice of CN) and the associated RN (or slice of RN) regarding the mapping of TA levels to the cells identifiers. The mapping is kept by both RN and CN, because RN broadcasts the TA and CN uses TA. For a slice of homogeneous mobility the mapping table consists of only one row, i.e., for a single TA level. For a slice of heterogeneous mobility, there are multiple rows in the table, i.e., for multiple TA levels. In some example embodiments, three rows, corresponding to three TA levels may be used. Having received the information regarding the TA granularity, the UE selects, or being assigned by the network to, one to use. At the same time the UE lets the network know its choice by signaling the selection to the network. Transmission of up to four TA levels requires two bits. As long as there are down stream data traffic or the UE is moving, the network can collect mobility data, so that a statistic parameter can be estimated based on collection over a given size of time window. Based on these statistics, the network instructs the UE to change the TA levels whenever necessary. The mechanism may use only a single bit, similar to the power control in the radio interface. When the mobility behavior of the UE does not change during the period of adaptation, an equilibrium can be reached, in which the association of TA with the UE is optimal in terms of power saving and resource efficiency.

The network operator may define values of threshold to facilitate the adaptation. Let the first threshold be the boundary crossings by the user equipment (UE). Reaching this value from below in a given time period may trigger the network to send a “level up” bit to the UE, piggy-backed to a paging message. As long as this threshold is not reached within the given time window size, no action is needed. Let the second threshold be paging response locations of UE (initiated by down stream traffic), counted in the recent fixed time window. If the paging response comes from a TA of level lower than the one the UE is using for TAU, a “level down” bit is sent to the UE, so that both network and UE start to use the new TA. The procedure follows a state machine operation and a state transition is triggered by up or down bit. The network maintains the state of the UE, which signals its state to the network by including the current TA level (two bits) in next up-stream messages.

In ideal case i.e., in equilibrium, the mobility level of an UE is mapped to the appropriate TA level, e.g., zero mobility to level 1 TA, low mobility to level 2 TA and high mobility to level 3 TA. How to achieve this equilibrium is the very task of the procedure design. For this purpose, a random walk can serve as the stochastic model for the mobility. The mathematical framework is a filtered probability space

(Ω,F,FₜP) (2)

where Ω the event set, F a σ-algebra on Ω, Fₜ the sequence of filters and P the probability measure. A random walk is a process XₜϵFₜ where t refers to time, so that the current location of the observed UE is given by the sum

$${Y}_{t} = {\sum }_{i = 0}^{t} {X}_{i} \qquad ( 3 )$$

at time t. If Xᵢ is IID, then Yᵢ is a martingale and, as such, allows for predication based on past values.

Any basic model for the mobility of a mobile user may assume two basic behaviors:
The original location, i.e., the initial reference point: Here we assume uniform distribution in a cell.
The probability distribution of the mobile user's spatial displacement: Here we can consider discrete model (simple) as well continuous model (insightful).

One-Dimensional Discrete Model

We use at first the following models to illustrate the principle: For an UE of high mobility (level 3)

$${X}_{t} = \{ \begin{matrix}1.5 & with probability {p}_{+ 2} = 1 / 5 \\ 0.5 & with probability {p}_{+ 1} = 1 / 5 \\ 0 & with probability {p}_{0} = 1 / 5 \\ - 0.5 & with probability {p}_{- 1} = 1 / 5 \\ - 1.5 & with probability {p}_{- 2} = 1 / 5\end{matrix} \qquad ( 4 )$$

For an UE of low mobility (level 2)

$${X}_{t} = \{ \begin{matrix}0.5 & with probability {p}_{+ 1} = 1 / 5 \\ 0 & with probability {p}_{0} = 1 / 5 \\ - 0.5 & with probability {p}_{- 1} = 1 / 5\end{matrix} \qquad ( 5 )$$

For an UE of no mobility (level 1)

Xₜ=0 with probability p₀=1 (6)
Level 1 TA: Single point 0
Level 2 TA: Interval [−1, 1]
Level 3 TA: Interval [−2, 2]

Thus goal of optimal mobility management is to find the best pair (ML, TA) in a matrix, e.g., of size 3×3, for mobility level (ML) and tracking area (TA). This is easily done when the value of the mobility level is strictly known. In case this is not known or not quantifiable, adaptive protocol can help, e.g., as following.

As soon as the UE is attached to the network, it is associated with a TA, either assigned by the network or selected by UE itself. This association may not be optimal, meaning the mobility level and the TA level may not match. Then, the TAU procedure facilitates achievement of the equilibrium, the state when each UE finds the associated TA level matching its mobility level. As soon as UE is assigned (or having selected) an initial TA, the network starts to collect the mobility statistic and, based on which, instruct the UE to change the TA selection when needed. The mobility statistics can be represented by the number of TA boundary crossings within a given size of time window, recorded as the number of TAUs initiated by the UE. For UE with low mobility, the mobility statistics can be based on counting different originating locations of the paging response within a time window. A threshold is set by the network and when it is reached by the statistic, a change of TA command is sent to the UE. Clearly, if the initial selection of TA level matches the UE mobility level, the threshold will never be reached and no change of TA is needed and no communication between network and UE regarding the TA takes place.

One-Dimensional Continuous Model

As long as we are addressing the statistic model and assume IID (independent identical distribution), we can drop the time dependence of the random variable Xt in the following without loss of generality. The initial location is characterized by the distribution density function

$${f}_{U} ( x ) = \frac{1}{2 L} \{ \begin{matrix}1 , for x ∈ [ - L , L ] \\ 0 , for x ∉ [ - L , L ]\end{matrix} \qquad ( 7 )$$

and the displacement is characterized by the exponential distribution

f_{D}(x)=αe^{-α|x|} for xϵR (8)

with shape parameter αϵR₊. Thus, the mean displacement has the probability density function

$$\begin{matrix}\begin{matrix}f ( x ) = {\int }_{- L}^{L} \frac{α}{2 L} {e}^{- α \vert x - {x}^{′} \vert} {dx}^{′} = {\int }_{- L}^{x} \frac{α}{2 L} {e}^{- α ( x - {x}^{′} )} {dx}^{′} + \\ {\int }_{x}^{L} \frac{α}{2 L} {e}^{- α ( {x}^{′} - x )} {dx}^{′} \\ = \frac{1}{2 L} [ 1 - {e}^{- α ( x - L )} + 1 - {e}^{- α ( L - x )} ] \\ = \frac{1}{L} [ 1 - {e}^{- α L} cosh ( α x ) ]\end{matrix} \\ for x ∈ [ - L , L ] , or \\ f ( x ) = {\int }_{- L}^{L} \frac{α}{2 L} {e}^{- α ( x - {x}^{′} )} {dx}^{′} = \frac{1}{2 L} {e}^{- α x} ( {e}^{α L} - {e}^{- α L} ) \\ for x > L , or & ( 9 ) \\ f ( x ) = {\int }_{- L}^{L} \frac{α}{2 L} {e}^{α ( x - {x}^{′} )} {dx}^{′} = \frac{1}{2 L} {e}^{α x} ( {e}^{α L} - {e}^{- α L} ) \\ for x < - L . In summary & ( 10 ) \\ f ( x ) = \frac{1}{L} \{ \begin{matrix}{e}^{ax} sinh ( α L ) & for x < - L \\ 1 - {e}^{- α L} cosh ( α x ) & for - L \leq x \leq L \\ {e}^{- α x} sinh ( α L ) & for x > L\end{matrix} & ( 11 )\end{matrix}$$

Depending on αϵR₊. We are interested in the conditional probability distribution function

Pr(X<x|α)=∫_{-∞}^{x}f(x)dx′ (12)

Let L_{TA} characterize the size of the TA. Then, [−L, L]⊂[−L_{TA}, L_{TA}] because tracking area cannot be smaller than the initial location area by definition. Then, Pr(X>L_{TA}|α) and Pr(X<−L_{TA}|α) measure the boundary crossing, i.e., the mobility of the UE. Due to the symmetry of the model, evaluation of only one-side of the distribution function suffices for the follow-up study. Thus, we will focus on

$$Pr ( X > {L}_{TA} \vert α ) = \frac{sinh ( α L )}{α L} {e}^{- α {L}_{TA}} \qquad ( 13 )$$

for L_{TA}≥T, where the lower bound L characterizes the initial location uncertainty of the UE, α the mobility and L_{TA} the tracking area. In particular

$$\begin{matrix}{lim}_{α -> 0} Pr ( X > {L}_{TA} \vert α ) = 1 & ( 14 ) \\ {lim}_{α -> ∞} Pr ( X > {L}_{TA} \vert α ) = 0 & ( 15 )\end{matrix}$$

Since lim_{α→0} f_{D}(x)=0 corresponds to infinite mobility, the first limit tells that boundary crossing is a sure event. Since lim_{α→∞} f_{D}(x)=δ(x) corresponds to zero mobility, the second limit tells that boundary crossing never happens. According to assumptions made before, the mobility level of the UE is quantified in this model by the parameter α=α₁, α₂, α₃, the mobility level, and the tracking area is quantified by L_{TA1},L_{TA2},L_{TA3}, the tracking area level. The TA adaptation process has the goal to minimize Pr(X>Lᵢ|αⱼ) for (i, j)ϵ{TA1,TA2,TA3}×{α₁,α₂,α₃} to find (i₀, j₀) such that

Pr(X>Lᵢ|αⱼ)≥Pr(X>Lᵢ₀|αⱼ₀) for all (i,j) (16)

under given conditions to be specified yet. Although the quantitative performance target is objective depending on operator, the common sense will however demand the bottom line

Pr(−L_{TA}≤X≤Lᵢ₀|αⱼ₀) for all (i,j) (17)

for any acceptable TA. This inequality can be viewed as one constraint for the design. The other constraint is the wasted paging, which is monotone increasing with LTA. From (13) follows

$${L}_{TA} = - \frac{1}{α} log [ Pr ( X > {L}_{TA} \vert α ) \frac{α L}{sinh ( α L )} ] \qquad ( 18 )$$

The task can be posed as minimizing L_{TA} for given Pr(X>L_{TA}) with respect to α and L. We carry out computation for the two variable, respectively:
Requesting

$$\frac{\partial {L}_{TA}}{\partial α} = \frac{1}{{α}^{2}} \{ log [ p \frac{α L}{sinh ( α L )} ] - \frac{1 - α L coth ( α L )}{p} \} = 0 \qquad ( 19 )$$

for fixed L and p may not lead to a unique solution, if any.
Requesting

$$\begin{matrix}\frac{\partial {L}_{TA}}{\partial α} = - \frac{sinh ( α L )}{α L} + cosh ( α L ) = 0 & ( 20 ) \\ lead to & \\ tanh ( α L ) = α L & ( 21 )\end{matrix}$$

This is a minimum point, since

$$\frac{\partial {L}_{TA}}{\partial {L}^{2}} = \frac{( 1 - {α}^{2} {L}^{2} ) sinh ( α L ) cosh ( α L )}{α {L}^{2}} > 0 \\ due to \\ \frac{1 + {x}^{2}}{x} - coth ( x ) > 0 \qquad ( 22 )$$

for x>0, noting coth(x)=x⁻¹+x/3−o(x). Thus, a unique solution L exists for non-trivial α. In another words, for given mobility behavior α, there is an optimal cell size L that minimizes the paging waste. Vice versa.

Two-Dimensional Model

Real cellular networks are better modeled by two dimensional geometry with more accuracy. The simplest such model is one that possesses rotation symmetry, for which the following assumptions may apply:
The cellular network has a rotation symmetrical structure.
A cell is an area circumvented by a circle of finite and identical radius.
Using displacement vector, only the projection to radial coordinate contributes to the mobility.

Assume a uniform distribution of the UE in each cell with the probability density function

$${f}_{U} ( x ) = 2 \frac{\vert x \vert}{{R}^{2}} \cdot \{ \begin{matrix}1 for \vert x \vert ∈ [ 0 , R ] \\ 0 else\end{matrix} \qquad ( 24 )$$

where the location xϵR2 of an UE is given by the polar co-ordinates (r cos ϕ,r sin ϕ) with r=|x| and R refers to the radius of the cell that the UE belongs to. A second assumption is that the displacement of the UE is subject to a Gaussian distribution with the probability density function

$${f}_{D} ( x ) = N ( {x}_{0} , σ ) = \frac{1}{σ \sqrt{2 π}} {e}^{- \frac{{[ x - {x}_{0} ]}^{2}}{2 {n}^{2}}} for x ∈ R \qquad ( 25 )$$

Here the standard deviation σ can serve as a measure for the mobility, e.g., proportional to the mobility level. The mean distribution density function of the displacement is the integral

$$\begin{matrix}f ( x ) = \frac{1}{σ \sqrt{2 π}} \frac{2}{{R}^{2}} {\int }_{0}^{R} {\int }_{0}^{2 π} exp \{ \frac{{r}^{2} + {r}^{′2} - 2 {rr}^{′} cos θ}{2 {σ}^{2}} \} {r}^{′} {dr}^{′} d θ & ( 26 ) \\ = \frac{1}{σ \sqrt{2 π}} {e}^{- \frac{{r}^{2}}{2 {σ}^{2}}} \frac{2}{{R}^{2}} {\int }_{0}^{R} {e}^{- \frac{{r}^{′2}}{2 {σ}^{2}}} [ {\int }_{0}^{2 π} {e}^{\frac{2 {rr}^{′} cos θ}{2 {σ}^{2}}} d θ ] {r}^{′} {dr}^{′} & ( 27 ) \\ = \frac{1}{σ \sqrt{2 π}} {e}^{- \frac{{r}^{2}}{2 {σ}^{2}}} \frac{4}{{R}^{2}} {\int }_{0}^{R} {e}^{- \frac{{r}^{′2}}{2 {σ}^{2}}} I 0 ( \frac{{rr}^{′}}{{σ}^{2}} ) {r}^{′} {dr}^{′} & ( 28 ) \\ = \frac{1}{σ \sqrt{2 π}} {e}^{- \frac{{r}^{2}}{2 {σ}^{2}}} \cdot W ( R , r / {σ}^{2} ) & ( 29 )\end{matrix} where$$

$${\int }_{0}^{2 π} {e}^{\frac{{rr}^{′} cos θ}{{σ}^{2}}} d θ = 2 {\int }_{0}^{π} cosh ( \frac{{rr}^{′} cos θ}{{σ}^{2}} ) d θ = 2 π {I}_{0} ( \frac{{rr}^{′}}{{σ}^{2}} ) ( 30 )$$

is inserted, owing to relation [2]

$${I}_{0} ( a ) = \frac{1}{π} {\int }_{0}^{π} cosh ( a cos θ ) d θ \qquad ( 31 )$$

and the following weight function was introduced

$$W ( R , r / {σ}^{2} ) = \frac{4 π}{{R}^{2}} {\int }_{0}^{R} {e}^{- \frac{{r}^{′2}}{2 {σ}^{2}}} {I}_{0} ( \frac{{rr}^{′}}{{σ}^{2}} ) {r}^{′} {dr}^{′} \qquad ( 32 )$$

Thus, the density function becomes a weighted Gaussian. The probability for boundary crossing, the measure for mobility performance, is then given by

Pr(|x|>R_{T}=σ)=∫_{R}_{_{T}}^{∞}f(r′)dr′ (33)

where R_{T}>R is the radius of the tracking area and σ the mobility measure of the UE. According to ([2])

$$I 0 ( z ) = 1 + \frac{\frac{1}{4} {z}^{2}}{{( 1 ! )}^{2}} + \frac{{( \frac{1}{4} {z}^{2} )}^{2}}{{( 2 ! )}^{2}} + \frac{{( \frac{1}{4} {z}^{2} )}^{3}}{{( 3 ! )}^{2}} + … \qquad ( 34 )$$

We obtain

$$W ( R , r / {σ}^{2} ) \geq \frac{π}{{R}^{2}} {σ}^{2} [ 1 - exp ( - \frac{{R}^{2}}{2 {σ}^{2}} ) ] \qquad ( 35 )$$

independent of r, so that we can estimate the lower bound

$$Pr ( \vert x \vert > {R}_{T} \vert σ ) \geq \frac{π}{{R}^{2}} {σ}^{2} [ 1 - exp ( - \frac{{R}^{2}}{2 {σ}^{2}} ) ] {\int }_{{R}_{T}}^{∞} \frac{1}{σ \sqrt{2 π}} {e}^{- \frac{{r}^{2}}{2 {σ}^{2}}} dr \qquad ( 36 )$$

### According to (|2|)

$${e}^{{x}^{2}} {\int }_{z}^{∞} {e}^{- {t}^{2}} dt \leq \frac{1}{x + \sqrt{{x}^{2} + 4 / π}} \qquad ( 37 )$$

we obtain the lower bound

$$Pr ( \vert x \vert > {R}_{T} \vert σ ) \geq \sqrt{π} \frac{[ 1 - exp ( - \frac{{R}^{2}}{2 {σ}^{2}} ) ] exp ( - \frac{{R}_{T}^{2}}{2 {σ}^{2}} )}{{( \frac{R}{σ} )}^{2} [ \frac{{R}_{T}}{\sqrt{2 σ}} + \sqrt{\frac{{R}_{T}^{2}}{\sqrt{2 {σ}^{2}}} + 4 / π} ]} \text{=} \text{:} B ( R , {R}_{T} , σ ) \qquad ( 38 )$$

For fixed R, the right hand increases with σ and decreases with R_{T}. Moreover

$${lim}_{{R}_{T} -> 0} {lim}_{R -> 0} B ( R , {R}_{T} , σ ) = {lim}_{{R}_{T} -> 0} \frac{\sqrt{π}}{2} \frac{exp ( - \frac{{R}^{2}}{2 {σ}^{2}} )}{[ \frac{{R}_{T}}{\sqrt{2 σ}} ] + \sqrt{\frac{{R}_{T}^{2}}{\sqrt{2 {σ}^{2}}} + 4 / π}} = π / 4 \qquad ( 39 )$$

For slice with homogeneous mobility, the advantage is obvious. A single TA definition cannot accommodate different slice with different mobility levels, while meeting the same energy and resource efficiency. It is imperative for some UEs in NextGen(5G) to be extreme low cost so that it can only accommodate minimum mobility management. Only a differential tracking area can provide adequate mobility management for different slices.

The evaluation for slice with heterogeneous mobility requires more efforts. It can be made by counting the wasted paging transmission and unnecessary TAU when comparing the proposed procedure with that of single TA procedure and mobile controlled procedure (timer based approach). Clearly, the paging activity depends on the traffic model pertinent to the UE and the associated services.

Mobility Management Procedure

Given that NextGen network is to provide end-to-end services for diverse enterprises, together with complete independent security, management and operation capability. A slice operator should offer the traditional general purpose subscriber service, e.g., mobile wireless access to communications medias under diverse circumstance, as well as special vertical services, e.g., IoT, Factor automation, health care, intelligent traffic etc. It is also envisioned that diverse device (UE) will be available to meet different user groups, i.e., general purpose terminal a la smart phone and laptop computer with versatile capability as well as special purpose device with low cost and long life expectation. To assemble a network slice, multiple network function is needed. Among other network functions, the mobility management can be designed in two ways:
The network consists of a default slice with common mobility function and some other service specific slices, each with differentiated mobility functions.
The network consists of a default slice without mobility function and some other service specific slices, each with full individualized mobility functions.

To make the architecture generic, we assume mobility management function (MMF) is present in the default as well as in specific slices. A sketch of the procedure of MMF operation can be as following:
The UE accesses the network through its default slice, by AS access followed by authentication and authorization on that default slice, both of AS and NAS.
The UE acquires MMF on the default slice and can, if it chooses and is authorized, dwell on the default slice, using the MMF provided by the default slice.
Alternatively, the UE can be transferred to a subscribed specific slice, after successful authentication and authorization by that targeted slice.
There are two cases at this point:

The slice is a general purpose slice and serves multi-purpose services: The slice offers N tracking area levels and assign the mobile one of those TAs to begin with. Depending on the mobility level the mobile possesses, an adaptation process starts and moves the UE to an optimal TA level, where the UE dwells until its mobility level changes. The adaptation procedure requires network assistance as described the previous sections.

The slice is a special purpose slice and provides service to users with specific mobility level: The UE adopt the TA offered by the network and stay with it.
Each UE may opt to entertain a sleep timer (ST) for the purpose of energy saving: When the timer is on, the UE reduces the power usage to the minimum, just enough to allow it to wake up when the timer expires. Upon wake-up, the UE listens to the broadcast and compares the received TAI and the one stored. If they don't match, it starts a TAU process. Otherwise, it remains silent until it initiates a session to the network or receives paging from the network, unless the sleep timer is turned on again. The schedule of the activities depends on the UE type and the services. The sleep timer values (on-time, off-time) can also be set by the network as configuration parameter of the respective slices.

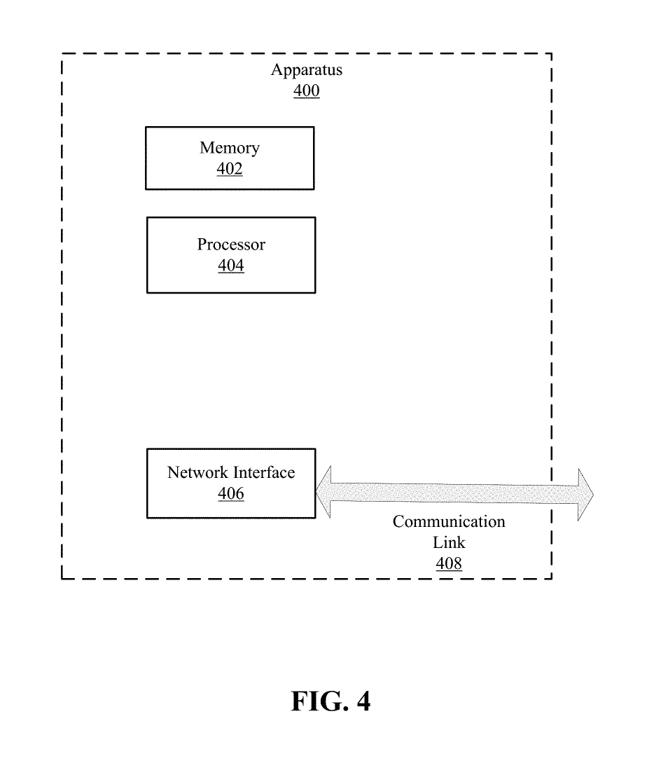

FIG. 4 is a block diagram representation of a computer apparatus 400 that can be used to implement methods and techniques described in the present document. The various functions described here (methods 500 or 600, described below and other techniques described above) could be implemented on a single hardware platform or in a distributed manner on multiple processors or in the cloud. The apparatus 400 includes one or more processors 402 that may read instructions from one or more memories 404, use the memory 404 for storing data, and may directly or via a network interface 406. The network interface 406 may be wired or wireless and may communicate messages using a communication link 408 with other devices to which the apparatus 400 is communicatively coupled.

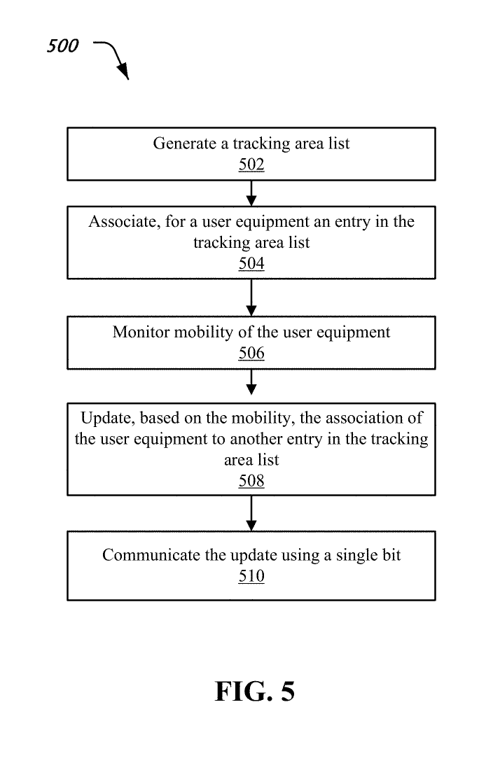

FIG. 5 is a flowchart depiction of a method 500 of wireless communication for updating tracking areas associated with one or more user equipment of a wireless communication network. The method 500 includes generating (502), by a network-server, a tracking area list comprising multiple entries, wherein each entry of the tracking area list comprises one or more tracking areas and at least some entries differ from each other based on their geographic coverage, associating (504) each of the one or more user equipment with at least one entry from the tracking area list, monitoring (506) movement of a given user equipment, updating (508), based on the movement, association of the given user equipment to a different entry from the tracking area list, and communicating (510), in an association update message, the updating using a single bit indicative of the updating of the association. The use of only a single bit to indicate the updates saves transmission and processing resources.

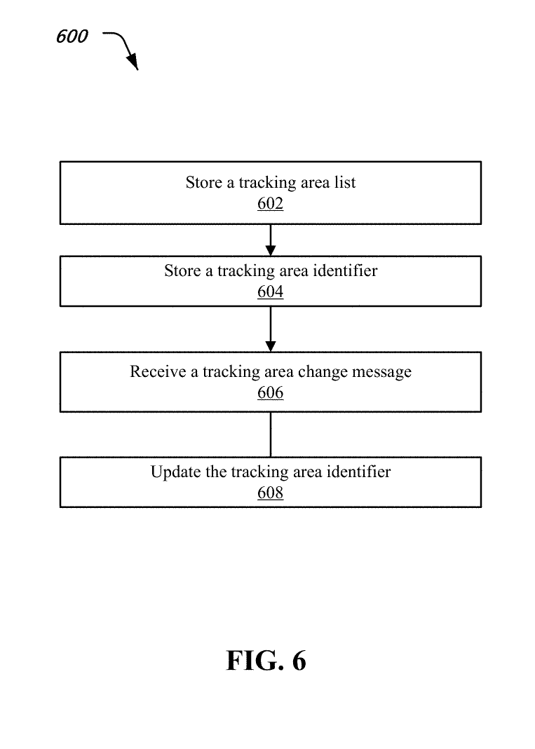

FIG. 6 is a flowchart representation of a method 600, implemented in a user device, comprising storing (602), in the local memory, a tracking area list comprising multiple entries, wherein each entry of the tracking area list comprises one or more tracking areas and at least some entries differ from each other based on their geographic coverage, storing (604) a tracking area identifier in a local memory at the user device, wherein the tracking area identifier a first entry in the tracking area list, receiving (606) a tracking area change message comprising exactly one bit, and updating (608), based on the tracking areas change message, the tracking area identifier to a different value indicative of a second entry in the tracking area list.

Standards such as the 3GPP TR 23.799 specification can be revised according to some of the techniques disclosed in the present patent document. For example, 3GPP TR 23.799 at section 6.3.28 Slice Dependent Tracking Area, or other section may modified according to the following or according to other section of this patent document.

Under mobility management with slice dependent tracking area, multiple tracking areas (TAs) can be defined for the same geographical area, but they may apply to different network slices and, as such, to different services.

Because each network slice (blue print) is tied to a type of an end-to-end service that it is supposed to support, the mobility of UEs served by each slice may be individual to the slice. Taking this into account, when TA is defined for each slice individually, pertinent to the mobility typical for the service of the slice, paging resource can be saved. The definition of the tracking area is, however, subject to an operator's decision.

From a service provision point of view, it is natural that a slice is given an individual TA to better support UEs that have subscribed to its service. In case a UE switches from one slice to another slice, the TA parameter applied to the same UE may change, due to the association between the TA and the network slice. In case the UE is attached to multiple slices simultaneously, it may choose one TA according to a predefined rule, e.g., use the largest TA from an ordered list, or follow the instruction by the network. In addition to saving on paging resource, this approach provides also a natural migration path from legacy to NextGen.

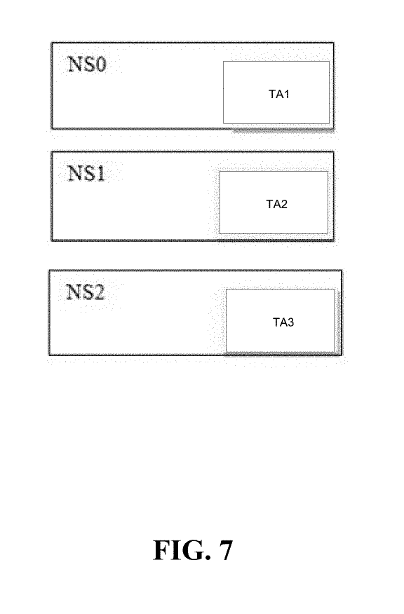

FIG. 7 depicts three slices. Notation: NS0, NS1, NS2 refer to different network slices. Each slice has its own definition of tracking area (TA), so that a UE uses a TA appropriate to the service defined for the slice. Different definitions of tracking area TA may be labelled differently (e.g., TA1, TA2, TA3) or color coded, indicating that the rule is at the operator's disposal.

The disclosed techniques can be extended to include support for secure communication within one or more standards. For example 3GPP TR 23.799 can be modified in one or more sections related to Solution to KI#12: Security Function (SECF) in Sliced Network.

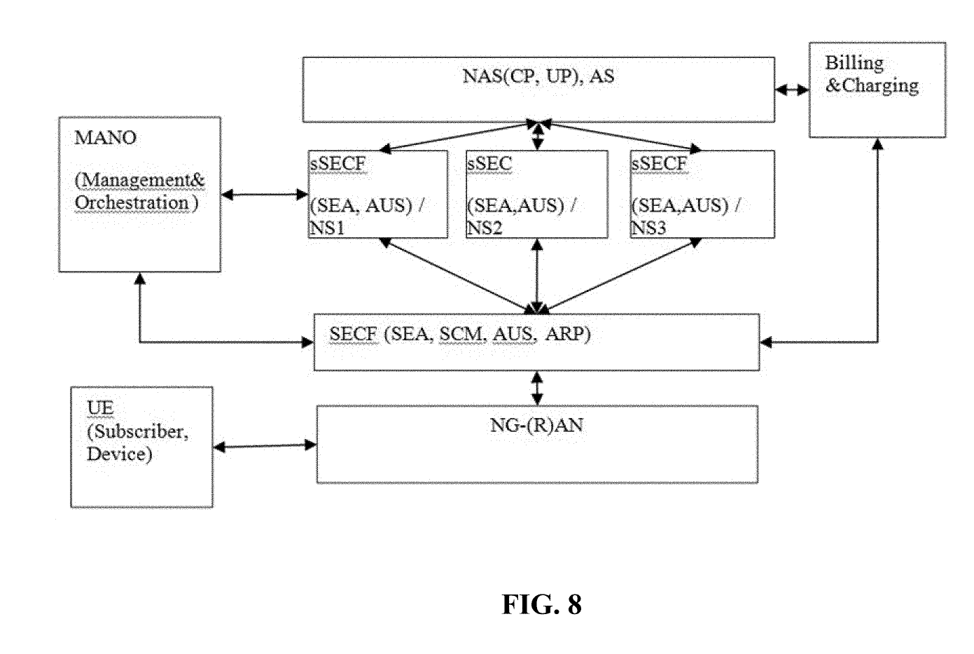

Security is present in almost all parts of NextGen, it handles not only the subscriber security but also the slice security, due to the network slicing (22.981). It is distributed, but can be grouped as a single security function (SECF) and a slice specific security function (sSECF), as part of SECF, see FIG. 8.

FIG. 8 depicts SECF and S-SECF, including 3 slices NS1, NS2, NS3, in accordance with some example embodiments. MANO is a function of the NFV that underlies the NextGen. FIG. 8 depicts SECF (Security Function) including ARP (Authentication Credential Repository and Processing) which holds and maintains long term credentials of subscriber, slice instances, end devices, etc. SECF also may include SEA (Security Anchor Function) which holds and maintains the security context of UE during the operation when UE is attached. SECF also may include AUS (Authentication Service Function) which carries out necessary authentication of subscribers, devices and slices, as well as boot strapping when needed. SECF also may include SCM (Security Context Management) which acts as a mediator between NAS and AS in term of security association and facilitates the authentication and authorization, as well as NextGen and the underlying infrastructure.

FIG. 8 also depicts sSECF (Slice specific Security Function) which may include SEA (Security Anchor Function) which holds slice specific security context material. SSEECF may also include AUS (Authentication Service Function) which assists SECF with authorization and booth strapping.

The security function may be a distributed function, not only in the sense it may be split into four sub-functions, but also that its operation may involve other network functions and provide services for other network functions. In particular, the authentication in NextGen may need interaction between a default slice (via CCNF of AMF) and a serving slice. ARP is a data base, conceptually part of UDM. But due to its special role and requirement, it should be treated differently.

In summary, security related network functions and reference points in the NextGen architecture may include: SECF (Security Function) includes sub-functions (SCM, SEA, AUS, ARP); CCNF includes S-SECF in NG-CP, assuming CCNF is part of AMF; sSECF (slice specific SECF) includes partial sub-functions (SEA, AUS); NG8: interface between SECF and NG-CP.

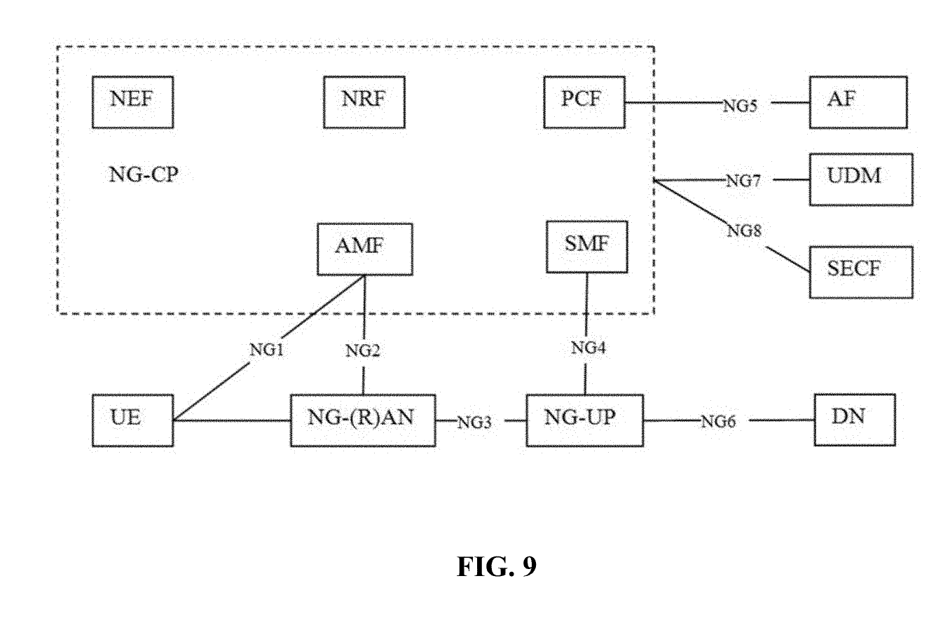

FIG. 9 depicts a non-roaming NextGen architecture, in accordance with some example embodiments. Various functional blocks currently under standardization in 3GPP, and their interfaces are depicted in FIG. 9.

It will be appreciated that architectural embodiments are disclosed for a next generation communication system in which user devices are permitted to roam.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method of updating tracking areas associated with one or more user equipment of a wireless communication network, comprising:
generating, by a network-server, a tracking area list comprising multiple entries, wherein each entry of the tracking area list comprises one or more tracking areas and at least some entries differ from each other based on their geographic coverage;
associating each of the one or more user equipment with at least one entry from the tracking area list;
monitoring movement of a first user equipment;
updating, based on the movement, association of the given user equipment to a different entry from the tracking area list; and
transmitting, to the first user equipment in an association update message, a single bit indicative of the updating.

2. The method of claim 1, wherein the single bit indicating of the updating comprises signaling one of increasing geographic reach of the tracking area associated with the given user equipment or reducing geographic reach of the tracking area associated with the given user equipment.

3. The method of claim 1, wherein at least some entries in the tracking area list include tracking areas that at least partially geographically overlap.

4. The method of claim 1, wherein the multiple entries of the tracking area list have an associated granularity indicative of geographic coverage.

5. The method of claim 1, further including:
associating, for each of the one or more user equipment, a default network slice, such that each user equipment is permitted to initially access network services through a corresponding default network slice.

6. The method of claim 5, wherein the default network slice controls the distribution of network functions among other slices in the wireless communication network.

7. An apparatus for updating tracking areas associated with one or more user equipment of a wireless communication network, comprising:
a network-server including a processor configured to at least:
generate a tracking area list comprising multiple entries, wherein each entry of the tracking area list comprises one or more tracking areas and at least some entries differ from each other based on their geographic coverage;
associate each of the one or more user equipment with at least one entry from the tracking area list;
monitor movement of a first user equipment; and
update, based on the movement, association of the given user equipment to a different entry from the tracking area list; and
a transmitter to transmit, to the first user equipment in an association update message, a single bit indicative of the updating.

8. The apparatus of claim 7, wherein the single bit indicating of the updating comprises signaling one of increasing geographic reach of the tracking area associated with the given user equipment or reducing geographic reach of the tracking area associated with the given user equipment.

9. The apparatus of claim 7, wherein at least some entries in the tracking area list include tracking areas that at least partially geographically overlap.

10. The apparatus of claim 7, wherein the multiple entries of the tracking area list have an associated granularity indicative of geographic coverage.

11. The apparatus of claim 7, wherein the processor is further configured to at least:
associate, for each of the one or more user equipment, a default network slice, such that each user equipment is permitted to initially access network services through a corresponding default network slice.

12. The apparatus of claim 11, wherein the default network slice controls the distribution of network functions among other slices in the wireless communication network.

13. A wireless communication method, implemented in a user device, comprising:
storing, in a local memory, a tracking area list comprising multiple entries, wherein each entry of the tracking area list comprises one or more tracking areas and at least some entries differ from each other based on their geographic coverage;
storing a tracking area identifier in the local memory at the user device, wherein the tracking area identifier includes a first entry in the tracking area list;
receiving a tracking area change message comprising exactly one bit; and
updating, based on the tracking area change message, the tracking area identifier to a different value indicative of a second entry in the tracking area list.

14. The method of claim 13, wherein the tracking area identifier identifies one or more geographic areas in which the user device is expected to operate.

15. The method of claim 13, wherein the exactly one bit indicating of the updating comprises signaling one of increasing geographic reach of the tracking area associated with the given user equipment or reducing geographic reach of the tracking area associated with the given user equipment.

16. The method of claim 13, wherein at least some entries in the tracking area list include tracking areas that at least partially geographically overlap.

17. The method of claim 13, wherein the multiple entries of the tracking area list have an associated granularity indicative of geographic coverage.

18. A wireless communication apparatus, implemented at a user device, comprising:
a processor configured to at least;
store, in a local memory, a tracking area list comprising multiple entries, wherein each entry of the tracking area list comprises one or more tracking areas and at least some entries differ from each other based on their geographic coverage; and
store a tracking area identifier in the local memory at the user device, wherein the tracking area identifier includes a first entry in the tracking area list; and
a receiver configured to receive a tracking area change message comprising exactly one bit, wherein the processor is further configured to update, based on the tracking area change message, the tracking area identifier to a different value indicative of a second entry in the tracking area list.

19. The wireless communication apparatus of claim 18, wherein the tracking area identifier identifies one or more geographic areas in which the user device is expected to operate.

20. The wireless communication apparatus of claim 18, wherein the exactly one bit indicating of the updating comprises signaling one of increasing geographic reach of the tracking area associated with the given user equipment or reducing geographic reach of the tracking area associated with the given user equipment.

21. The wireless communication apparatus of claim 18, wherein at least some entries in the tracking area list include tracking areas that at least partially geographically overlap.

22. The wireless communication apparatus of claim 18, wherein the multiple entries of the tracking area list have an associated granularity indicative of geographic coverage.
